(19) United States
(12) Patent Application Publication
(10) Pub. No.: US 2011/0037334 A1
(43) Pub. Date: Feb. 17, 2011

(54) FASTENING STRUCTURE FOR MOTOR MAGNETS

(76) Inventor: Gwo-Rong Lay, Taichung County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/988,245

(22) PCT Filed: Oct. 14, 2008
(86) PCT No.: PCT/CN08/72673

§ 371 Date: Oct. 15, 2010

(30) Foreign Application Priority Data
Apr. 17, 2008 (CN) 200820110458.2

(51) Int. Cl. H02K 23/04

(52) U.S. Cl. 310/154.08

(57) ABSTRACT

A fastening structure for motor magnets primarily includes: a casing formed with a pair of magnet-positioning means, which are opposite to each other on the casing; a rotor installed in the casing; two magnets providing magnetic force to the rotor and each being installed in the corresponding magnet-positioning means, and a fixing sleeve mounted around the casing for providing an external fixing force to the magnets. Thereby, the disclosed structure helps to eliminate problems related to complicated fabrication required by the prior art.

### BACKGROUND OF THE INVENTION

1. Technical Field

The present invention relates to motors, and more particularly, to a fastening structure for motor magnets.

2. Description of Related Art

According to the known principles of motors, a current supplied by an external power source and passing conducive wiring of a rotor generates a magnetic field that interacts with a magnetic field of stators so as to make the rotor rotate. Thus, a motor is basically composed of a casing, a rotor and two magnets (stators). In fabrication of such a motor, two positioning members provided in the casing each receive an end of either said magnet, so as to position the two magnets with respect to an inner surface of the casing. At least one partition is provided between free ends of the two magnets, thereby firmly fixing the magnets in the casing. The rotor is then installed. Since the magnets are settled on the inner surface of the casing, the motor is an internal magnet motor. However, the internal magnet motor meets problems during installation of the rotor. The magnetic effect between the magnets and the rotor tends to bias the rotor from an axis of the casing when the rotor is placed into the casing, making the rotor become jammed with the casing. Consequently, in fabrication, the procedure of installing the rotor may be repeated many times until the rotor is correctly aligned with the axis of the casing.

### SUMMARY OF THE INVENTION

The objective of the present invention is to provide a fastening structure for motor magnets, for addressing the problem of the foregoing internal magnet motor where the magnets hinder installation of the rotor, so as to allow more convenient and reliable fabrication.

The fastening structure for motor magnets of the present invention comprises:

a casing formed with a pair of magnet-positioning means, which are opposite to each other on the casing;

a rotor installed in the casing; and

two magnets providing magnetic force to the rotor and each being installed in one said magnet-positioning means.

Therein, each of the magnet-positioning means is a through hole passing through a thickness of the casing.

Therein, each of the magnet-positioning means is a socket sunken from an outer surface of the casing.

Therein, the magnets and the magnet-positioning means are in a peripheral tight-fit engagement.

Therein, at least two edges of each of the magnets and at least two edges of the corresponding magnet-positioning means have matching slopes, so that the magnets and the magnet-positioning means, when combined, come into the peripheral tight-fit engagement.

Therein, each of the magnets has at least two edges formed as protruding curved edges that fit flat edges of the corresponding magnet-positioning means, so that the magnets and the magnet-positioning means, when combined, come into the peripheral tight-fit engagement.

Therein, a fixing sleeve is mounted around the casing for providing an external fixing force to the magnets, so as to prevent the magnets from leaving the casing.

There is at least one beneficial effect of the present invention. That is, since the magnets are arranged on the outer surface of the casing, the motor is an external magnet motor. In virtue of its external magnet structure, such a motor helps to eliminate problems related to complicated fabrication as happen in the prior art.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a perspective view of a first embodiment of the present invention;

FIG. 2 is an exploded view of the first embodiment of the present invention;

FIG. 3 is an assembled cross-sectional view of the first embodiment of the present invention;

FIG. 4 is a perspective view of a second embodiment of the present invention; and

FIG. 5 is an exploded view of the second embodiment of the present invention.

### DETAILED DESCRIPTION OF THE INVENTION

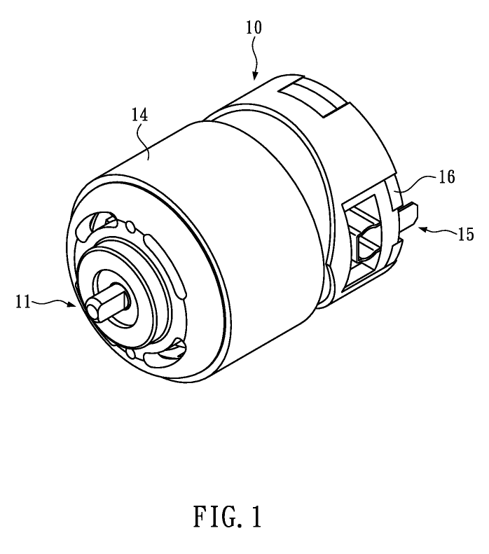

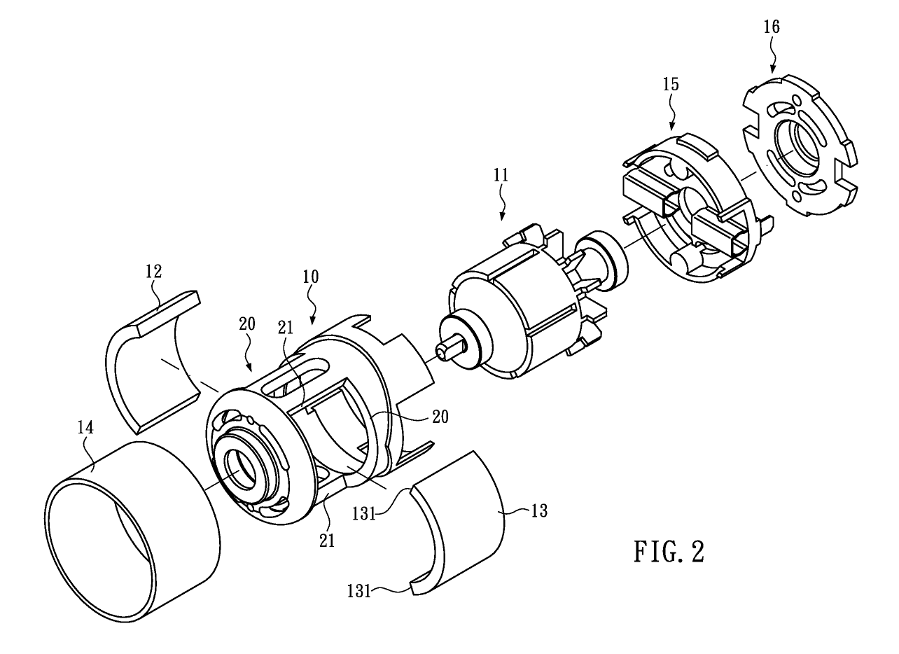

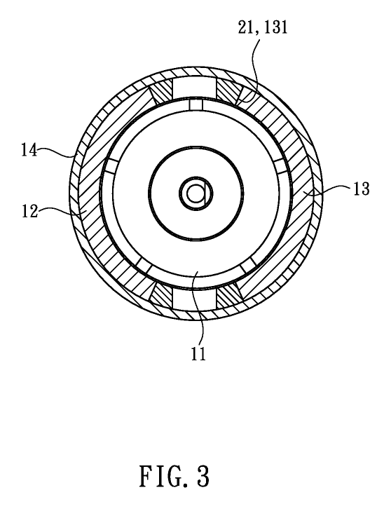

Referring to FIG. 1, FIG. 2 and FIG. 3, according to the present invention, a motor primarily comprises a casing 10, a rotor 11, two magnets 12, 13, and a fixing sleeve 14. The casing 10 is formed with a pair of magnet-positioning means 20, which are opposite to each other on the casing 10 and configured to accommodate the two magnets 12, 13. The magnet-positioning means 20 each may be a through hole communicated with an interior of the casing 10, or may be a socket being sunken from an outer surface of the casing 10. In the latter case, it is to be noted that a thickness of the casing 10, namely a distance from a bottom of the socket to an inner surface of the casing 10, has to allow magnetic force of the magnets 12, 13 to act on the rotor 11 through a thickness of the casing 10. The motor as shown in FIG. 1, FIG. 2 and FIG. 3 further comprises a brush seat 15 and a rear cover 16 attached to a rear end of the casing 10.

For assembling the motor of the present invention, the rotor 11 is first settled in the casing 10, and the two magnets 12, 13 are settled in the magnet-positioning means 20, respectively. Afterward, the fixing sleeve 14 is mounted around the casing 10, so as to retain the two magnets 12, 13 from leaving the casing 10.

In the present invention, since the magnets 12, 13 are arranged on the outer surface of the casing 10, the motor is an external magnet motor. In virtue of its external magnet structure, such a motor helps to eliminate problems related to complicated fabrication as happen in the prior art. In fabrication of the present invention, since the rotor 11 is settled in the casing 10 before the two magnets 12, 13 are assembled, installation of the rotor 11 is free from the influence of the magnetic force from the two magnets, so the rotor 11 is unlikely to have the problem of being jammed with the casing as happens in the prior art. Then when the two magnets 12, 13 is installed in the magnet-positioning means 20, magnetic attraction now existing between the magnets 12, 13 and the rotor 11 serves to hold the magnets 12, 13 in position. Thereby, the motor has the magnetism-related components assembled.

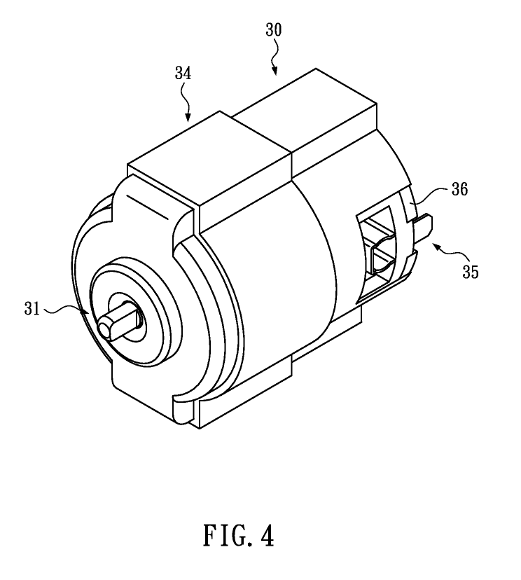

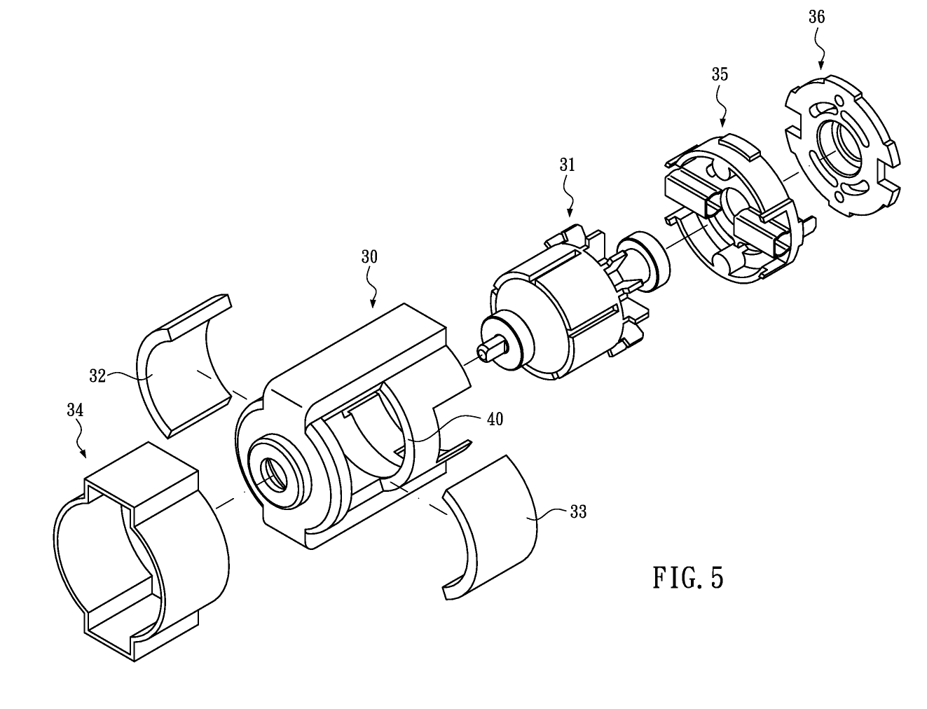

As shown in FIG. 4 and FIG. 5, in another embodiment of the present invention, a motor primarily comprises a casing 30, a rotor 31, two magnets 32, 33, and a fixing sleeve 34. The casing 30 is formed with a pair of magnet-positioning means 40, which are opposite to each other on the casing 10 and configured to accommodate the two magnets 32, 33. The magnet-positioning means 40 each may be a through hole communicated with an interior of the casing 30, or may be a socket being sunken from an outer surface of the casing 30. In the latter case, it is to be noted that a thickness of the casing 30, namely a distance from a bottom of the socket to an inner surface of the casing 30, has to allow magnetic force of the magnets 32, 33 to act on the rotor 31 through a thickness of the casing 30.

The way to assemble the motor in the present embodiment is identical to that described in the previous embodiment. Through the structure as shown in FIG. 4 and FIG. 5, it would be appreciated by people skilled in the art that the casing and the fixing sleeve may be alternatively shaped according to practical needs, without limitation.

Other particulars of the present invention are now described with reference to the first embodiment. However, these particulars are also applicable to the second embodiment.

When the magnets 12, 13 of the motor are settled on the magnet-positioning means 20, in addition to the magnetic attraction between the rotor 11 and the magnets 12, 13 that retains the magnets 12, 13, a periphery of each of the magnets 12, 13 is configured to be fittingly engaged with a periphery of the corresponding magnet-positioning means 20. As shown in the drawings, at least two edges of each of the magnets 12, 13 and at least two edges of the corresponding magnet-positioning means 20 have matching slopes 21, 131, so that the magnets 12, 13 and the magnet-positioning means 20 come into a peripheral tight-fit engagement, thereby fixing the magnets 12, 13. Alternatively, each of the magnets 12, 13 may have at least two edges formed as protruding curved edges that fit flat edges of the corresponding magnet-positioning means 20, so as to achieve a similar peripheral tight-fit engagement between the components. In fact, the peripheral tight-fit engagement between the magnets 12, 13 and the magnet-positioning means 20 may be realized by any feasible means.

Use of the fixing sleeve 14 is optional, according to practical needs. In principle, the fixing sleeve 14 may be made into any form, but not limited to those shown in the drawings. The fixing sleeve 14 serves to provide an external fixing force to the magnets 12, 13, so as to prevent the magnets 12, 13 from leaving the casing under magnetic repulsion generated when the motor operates. Furthermore, as shown in the drawings, by properly selecting the shape and material of the fixing sleeve, the magnetic force may be focused in the casing without escaping, so as to ensure the magnetic effect between the rotor and the magnets.

As to the casing 10 of the present invention, it may be made of metal or plastic.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A fastening structure for motor magnets, comprising:
a casing (10,30) formed with a pair of magnet-positioning means (20,40), which are opposite to each other on the casing (10,30);
a rotor (11,31) installed in the casing (10,30); and
two magnets (12,13), (32,33) providing magnetic force to the rotor (11,31) and each being installed in one said magnet-positioning means (20,40).

2. The fastening structure of claim 1, wherein each of the magnet-positioning means (20,40) is a through hole passing through a thickness of the casing (10,30).

3. The fastening structure of claim 1, wherein each of the magnet-positioning means (20,40) is a socket sunken from an outer surface of the casing (10,30).

4. The fastening structure of claim 1, wherein the magnets (12,13) and the magnet-positioning means (20) are in a peripheral tight-fit engagement.

5. The fastening structure of claim 4, wherein at least two edges of each of the magnets (12,13) and at least two edges of the corresponding magnet-positioning means (20) have matching slopes (21,131), so that the magnets (12,13) and the magnet-positioning means (20), when combined, come into the peripheral tight-fit engagement.

6. The fastening structure of claim 4, wherein each of the magnets (12,13) has at least two edges formed as protruding curved edges that fit flat edges of the corresponding magnet-positioning means (20), so that the magnets (12,13) and the magnet-positioning means (20), when combined, come into the peripheral tight-fit engagement.

7. The fastening structure of claim 1, further comprising a fixing sleeve (14,34) mounted around the casing (10,30) for providing an external fixing force to the magnets (12,13), (32,33), so as to prevent the magnets (12,13), (32,33) from leaving the casing (10,30).
